(19) United States
(12) Patent Application Publication
(10) Pub. No.: US 2010/0058379 A1
(43) Pub. Date: Mar. 4, 2010

(54) METHOD AND SYSTEM FOR SELECTING A MOVIE FOR VIEWING

(75) Inventors: Yen-Kwang Lin, Raleigh, NC (US); Anne I. Ryan, Palo Alto, CA (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/199,529

(22) Filed: Aug. 27, 2008

(51) Int. Cl. H04N 7/18; H04N 7/173

(52) U.S. Cl. 725/24; 725/87

(57) ABSTRACT

A movie selection method and system is provided for selecting a movie for viewing. The method includes displaying a plurality of movie titles over a network, each one of the plurality of movie titles corresponding to a candidate movie. The method further includes receiving at least one vote corresponding to one of the plurality of movie titles, and determining a winning movie based on the at least one vote. The winning movie is to be presented in a movie theater. The method further includes initiating a payment transaction for each user who voted for the winning movie. As a result, the method and system disclosed herein enables users to choose which movies are shown in the movie theater and enables the movie theater to increase profits.

### BACKGROUND OF THE INVENTION

Watching movies in movie theaters has been a long-time form of entertainment for many people. Because of increasing costs for movie theaters, as well as the desire to increase profits, most movie theaters will not show a given film unless the film can attract a sufficiently large audience (e.g., at least 1,500 people over a two-week run). Such popular films are referred to as blockbuster films. One problem with the requirement of attracting such a large audience is that it is primarily blockbuster films that are shown at most movie theaters. There are movie theaters that specialize in independent films and/or older films. However, the number of these movie theaters is decreasing as operation costs and competition from multiplex theaters increase. Consequently, movie goers have fewer opportunities to view non-blockbuster films such as independent and older films at movie theaters.

### BRIEF SUMMARY OF THE INVENTION

A movie selection method and system is provided for selecting a movie for viewing. The method includes displaying a plurality of movie titles over a network, each one of the plurality of movie titles corresponding to a candidate movie. The method further includes receiving at least one vote corresponding to one of the plurality of movie titles, and determining a winning movie based on the at least one vote. The winning movie is to be presented in a movie theater. The method further includes initiating a payment transaction for each user who voted for the winning movie. As a result, the method and system disclosed herein enables users to choose which movies are shown in the movie theater and enables the movie theater to increase profits.

### BRIEF DESCRIPTION OF THE DRAWINGS

FIG. 1 is a logical block diagram illustrating an exemplary network system environment in which one embodiment of the present invention may be implemented for selecting a movie to be shown at a movie theater.

FIG. 2 is a diagram illustrating a process for selecting a movie to be shown at a movie theater.

FIG. 3 is a diagram illustrating one embodiment for enabling customers to vote for a movie to be shown in a movie theater.

### DETAILED DESCRIPTION OF THE INVENTION

The present invention relates to a method and system for selecting a movie for viewing. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiment enables movie goers to choose what movies are shown at a given movie theater. Such movies may include non-mainstream movies and older movies. Generally, a given movie to be shown at a given movie theater is selected based on votes by customers. In a specific embodiment, a movie theater administrator provides a movie application with movie titles corresponding to candidate movies to be voted upon by the customers. The movie application displays the movie titles on a website associated with the movie theater. The customers may then vote on the movie that they want to view at the movie theater. After the movie application receives all of the votes, the movie application determines the winning movie based on the votes. In one embodiment, the movie application also initiates a payment transaction (e.g., charges a credit card) for each customer who voted for the winning movie. As a result, customers are allowed to choose which movies are shown in the movie theater and the movie theater can increase profits.

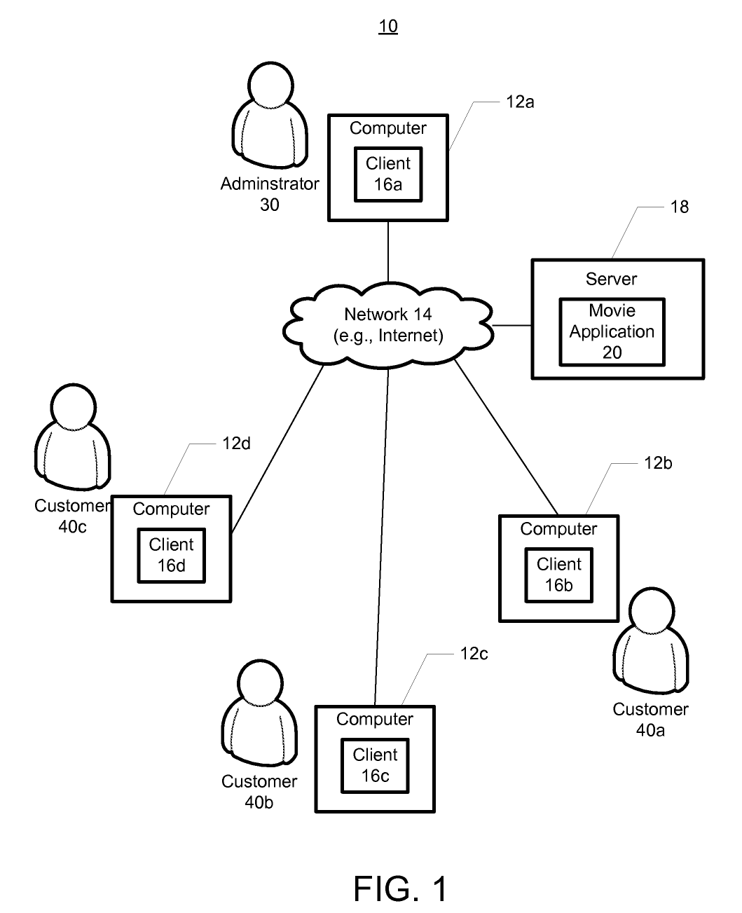

FIG. 1 is a logical block diagram illustrating an exemplary network system environment in which one embodiment of the present invention may be implemented for selecting a movie to be shown at a movie theater. A network system environment 10 is shown in which two or more computers 12a, 12b, 12c, and 12d communicate over a network 14. The network 14 may be a public network, such as the Internet, or a private network, such as an intranet, LAN, or WLAN, or a combination thereof. At least a portion of the computers 12a-d may execute respective clients 16a, 16b, 16c, and 16d for communicating with a server 18 over the network 14. In particular embodiments, the server 18 includes a movie application 20. The movie application 20 may be stored in a memory of the server 18 or on any other suitable storage location or computer-readable medium. The movie application 20 provides instructions that when executed by a processor of server 18 perform the functions described herein.

In one embodiment, an administrator 30 of the movie theater sets or allots one or more time slots to show a movie. In one embodiment the movie to be selected for viewing is a non-blockbuster movie. The movie to be selected may be one of any type of genre (e.g., documentary, foreign, or classic, etc.). In one embodiment, the administrator 30 selects the genre. In one embodiment, the genre selection may be based on census data to help determine movies would be more popular. The administrator then selects two or more different movie titles from which users or customers 40a, 40b, and 40c may select. For ease of illustration, only three customers 40a-c are shown. There may be many more customers (e.g., hundreds or thousands of customers, or more).

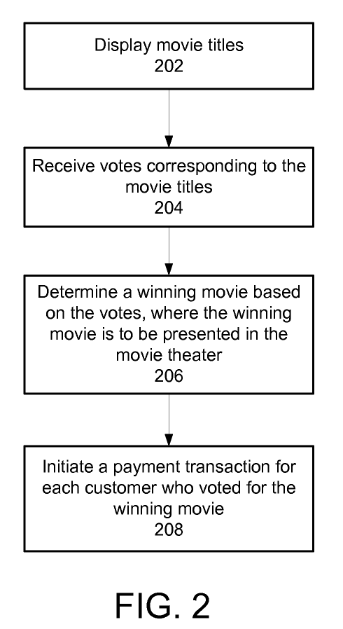

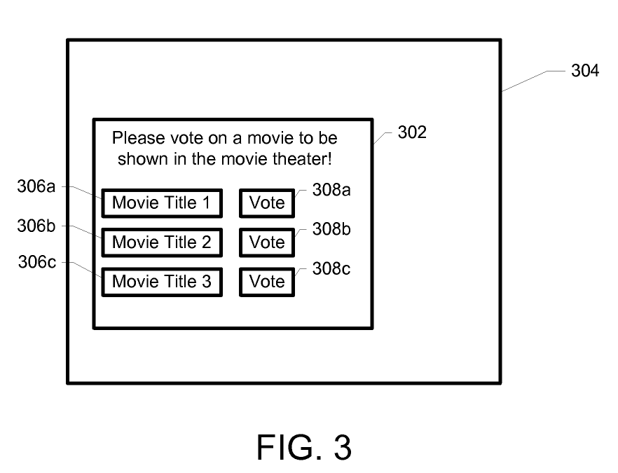

FIG. 2 is a diagram illustrating a process for selecting a movie to be shown at a movie theater. The movie application 20 may receive from the administrator 30 two or more movie titles, each of the movie titles corresponding to a candidate movie to be shown in the movie theater. Alternatively, the movie application 20 may automatically select the movie titles from a database of movie titles. The movie application 20 then displays the movie titles over a network (block 202). In a specific embodiment, the movie application 20 displays the movie titles on a website associated with the movie theater. In an alternative embodiment, the movie application 20 may display the movie titles using a cable or satellite television set top box. Furthermore, a given user may use any suitable means for providing input to the website and/or set top box (e.g., keyboard, remote control, joystick, etc.). FIG. 3 is a diagram illustrating one embodiment for enabling users or customers 40a-c to vote for a movie to be shown in a movie theater. As FIG. 3 shows, a vote window 302 in a movie theater website 304 prompts the user or customer to vote for a movie to be shown in the movie theater according to one embodiment. The vote window 302 includes a list of movie titles 306a, 306b, and 306c and corresponding vote buttons 308a, 308b, and 308c.

In particular embodiments, customers 40a-c log onto the movie theater website 304 and create user accounts. In one embodiment, each of the customers 40a-c provides a credit card number for purchasing movie tickets, concessions, etc. Once a given customer 40 creates an account, the customer 40 may then vote for or select the candidate movie that the customer 40 wishes to see. In one embodiment, each customer 40a-c selects a movie title from the list and orders one or more movie tickets, and may also order concessions. In an alternative embodiment, after the customers 41a-c create account, the movie application 20 may e-mail the movie titles to the customers 41 a-c with embedded voting links to website 304 to implement the voting.

The movie application 20 receives from the respective customers' 40a-c votes corresponding to the movie titles (block 204). In one embodiment, each selection for a given movie title counts for a vote for the corresponding candidate movie. The movie application 20 then determines a winning movie based on the votes, where the winning movie is to be shown in the movie theater (block 206). In one embodiment, the movie application 20 computes the number of votes for each candidate movie and identifies the winning movie, the winning movie being the candidate movie having the highest number of votes. In a specific embodiment, it is possible that the winning movie results from only one vote being cast. Also, in one embodiment, it is possible that one customer may vote for a given movie multiple times. This would result in multiple movie tickets being purchased (e.g., one vote per ticket). This would be advantageous for customers planning group activities.

The movie application 20 then initiates a payment transaction for each customer who voted for the winning movie (block 208). In one embodiment, for each of the purchased tickets, the movie application 20 initiates a payment transaction by automatically charging a credit card corresponding to each customer who voted for the winning movie. In one embodiment, the movie theater makes money whether or not the winning voters actually attend the movie. In one embodiment, each customer provides a credit card number and authorization before the movie application 20 receives the votes. In one embodiment, the movie application 20 may send the customers who did not vote for the winning movie information about the winning movie and offer movie tickets to those customers. In one embodiment, the movie theater may sell the remaining tickets online and at the box office. The movie application 20 may also offer concessions to all voters.

The movie application 20 subsequently displays or shows the winning movie in the movie theater during an allocated time slot(s). In one embodiment, the movie application 20 may automatically show the movie in the movie theater during the allocated time slot(s). In an alternative embodiment, the movie application 20 sends the movie title corresponding to the winning movie to the administrator 30 who to may then initiate the showing of the movie. The movie application 20 may send the administrator 30 an email indicating the winning movie or may alternatively display the title of the winning movie on the monitor of the administrator 30.

Embodiments of the present invention are ideal for movie theaters that use digital projectors. For example, in one embodiment, the movie voting may end a day or two before the allotted time slot in order to allow for shipment of the digital media (e.g., DVD) to the movie theater. In one embodiment, the movie application 20 may store movies on the server 18, allowing the movie theater to download the movie onto a suitable digital media before the showing or even stream the movie in real time to a digital projector. In one embodiment, a movie on digital media shared with other movie theaters may be password protected so it is viewed only a predefine number of times (e.g., 50 times).

According to the system and method disclosed herein, the present invention provides numerous benefits. For example, embodiments of the present invention allow movie goers to choose what movies are shown in movie theaters, including older movies that are now only available for home viewing (e.g., on VHS or DVD). Embodiments of the present invention also give movie theaters the potential to exploit a market of customers who prefer less-mainstream films, thus making more profit. Embodiments of the present invention also allow movie studios to potentially market paraphernalia from the older/obscurer films to those who become interested in them based on theater viewing.

A system of method for selecting a movie for viewing in a movie theater has been disclosed. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for selecting a movie for viewing, the method comprising:
displaying a plurality of movie titles over a network, each one of the plurality of movie titles corresponding to a candidate movie;
receiving at least one vote corresponding to one of the plurality of movie titles;
determining a winning movie based on the at least one vote, wherein the winning movie is to be presented in a movie theater; and
initiating a payment transaction for each user who voted for the winning movie.

2. The method of claim 1 wherein the initiating comprises charging a credit card corresponding to each user who voted for the winning movie, wherein each user provides a credit card number and authorization before the at least one vote is received.

3. The method of claim 1 wherein the determining comprises:
for each candidate movie, computing a number of votes; and
identifying the winning movie, the winning movie being the candidate movie having a highest number of votes.

4. The method of claim 1 further comprising displaying the plurality of movie titles in a vote window.

5. The method of claim 4 wherein the vote window comprises:
a list of the plurality of movie titles; and
a plurality of buttons, each button corresponding to one of the plurality of movie titles.

6. The method of claim 1 wherein an administrator provides the plurality of movie titles.

7. The method of claim 1 wherein at least one user provides the at least one vote.

8. The method of claim 1 further comprising displaying the winning movie in the movie theater.

9. The method of claim 1 further comprising sending a movie title corresponding to the winning movie to an administrator.

10. The method of claim 1 further comprising prior to displaying the movie titles, selecting the plurality of movie titles by at least one of: receiving from an administrator two or more of the movie titles, and automatically selecting the two or more movie titles from a database.

11. An executable software product stored on a computer-readable medium containing program instructions for selecting a movie for viewing, the program instructions for:
displaying a plurality of movie titles over a network, each one of the plurality of movie titles corresponding to a candidate movie;
receiving at least one vote corresponding to one of the plurality of movie titles;
determining a winning movie based on the at least one vote, wherein the winning movie is to be presented in a movie theater; and
initiating a payment transaction for each user who voted for the winning movie.

12. The executable software product of claim 11 wherein the initiating comprises charging a credit card corresponding to each user who voted for the winning movie, wherein each user provides a credit card number and authorization before the at least one vote is received.

13. The executable software product of claim 11 wherein the determining comprises:
for each candidate movie, computing a number of votes; and
identifying the winning movie, the winning movie being the candidate movie having a highest number of votes.

14. The executable software product of claim 11 further comprising displaying the plurality of movie titles in a vote window.

15. The executable software product of claim 14 wherein the vote window comprises:
a list of the plurality of movie titles; and
a plurality of buttons, each button corresponding to one of the plurality of movie titles.

16. The executable software product of claim 11 wherein an administrator provides the plurality of movie titles.

17. The executable software product of claim 11 further comprising displaying the winning movie in the movie theater.

18. The executable software product of claim 11 further comprising sending a movie title corresponding to the winning movie to an administrator.

19. The executable software product of claim 11 further comprising prior to displaying the movie titles, selecting the plurality of movie titles by at least one of: receiving from an administrator two or more of the movie titles, and automatically selecting the two or more movie titles from a database.

20. A movie selection system comprising:
a processor; and
a memory for storing a movie application comprising instructions that when executed by the processor perform functions for:
displaying a plurality of movie titles over a network, each one of the plurality of movie titles corresponding to a candidate movie;
receiving at least one vote corresponding to one of the plurality of movie titles;
determining a winning movie based on the at least one vote, wherein the winning movie is to be presented in a movie theater; and
initiating a payment transaction for each user who voted for the winning movie.

21. The system of claim 20 wherein the processor further performs functions for charging a credit card corresponding to each user who voted for the winning movie, wherein each user provides a credit card number and authorization before the at least one vote is received.

22. The system of claim 20 wherein the processor further performs functions for:
for each candidate movie, computing a number of votes; and
identifying the winning movie, the winning movie being the candidate movie having a highest number of votes.

23. The system of claim 20 wherein the processor further performs functions for displaying the plurality of movie titles in a vote window.

24. The system of claim 20 wherein the processor further performs functions for:
a list of the plurality of movie titles; and
a plurality of buttons, each button corresponding to one of the plurality of movie titles.

25. The system of claim 20 wherein an administrator provides the plurality of movie titles.
